(19) United States
(12) Patent Application Publication
(10) Pub. No.: US 2020/0284671 A1
(43) Pub. Date: Sep. 10, 2020

(54) METHOD FOR DETECTING AN ANOMALY OF A ROLLING EQUIPMENT EXPLOITING A DEFORMATION SIGNAL FROM A RAIL SUPPORT

(71) Applicant: COMMISSARIAT À L'ÉNERGIE ATOMIQUE ET AUX ÉNERGIES ALTERNATIVES, Paris (FR)

(72) Inventor: Sylvain Leirens, Grenoble (FR)

(21) Appl. No.: 16/806,339

(22) Filed: Mar. 2, 2020

(30) Foreign Application Priority Data
Mar. 4, 2019 (FR) 1902204

(51) Int. Cl. G01L 1/25; G01L 5/00; B61L 23/04

(52) U.S. Cl. CPC G01L 1/25; B61L 23/045; G01L 5/0047

(57) ABSTRACT

The invention relates to a computer-implemented method for detecting an anomaly of a rolling equipment rolling on rails of a railway resting on a rail support. This method comprises a decomposition (DECOMP) by discrete wavelet transform of a measurement signal (S) transmitted by a strain sensor detecting the deformation of the rail support into an approximation signal (A_{J}) and a residual signal (R_{J}) and a search (RECH-PA) for outliers (PA) in the residual signal (R_{J}) in order to detect an anomaly of the rolling equipment.

### CROSS-REFERENCE TO RELATED APPLICATIONS

This application claims priority from French Patent Application No. 1902204 filed on Mar. 4, 2019. The content of this application is incorporated herein by reference in its entirety.

### TECHNICAL FIELD

The field of the invention is that of monitoring the condition of an equipment rolling on railway tracks, in particular a train, a metro or a tram. The invention more particularly relates to the detection of anomalies of such rolling equipment based on rail support deformation measurements.

### PRIOR ART

Rail supports for railways are objects that are placed beneath the rails to provide the latter with a support adapted to the stresses to which the rails are subjected and to maintain the spacing therebetween while distributing the loads over the bed of these supports, for example ballast or a concrete slab. These supports can be sleepers or supports for railway equipment at switches.

As described in the article by V. Belotti et al. entitled “Wheel-flat diagnostic tool via wavelet transform,” Mech. Syst. Signal Process., vol. 20, No. 8, pp. 1953-1966, November 2006, these supports can be instrumented with accelerometers for the detection of flat spots on train wheels (such wheels being referred to as having wheel-flats hereafter). This detection is carried out by means of a discrete wavelet transform of the signals provided by the accelerometers. The coefficients of the two highest levels of decomposition into wavelets are exploited in order to detect the passage of the axles opposite an accelerometer and to deduce therefrom the speed of the train and construct a mask used during the detection of wheel-flats to minimise false alerts. This detection is carried out by comparing the non-masked coefficients of a low level wavelet decomposition with a threshold. This method is relatively complex as a result of the use of masking and is based on an acceleration measurement linked to the rail-wheel contact force which is difficult to model and thus to analyse.

Rail supports can also be instrumented, for example by integrating optical fibre Bragg grating sensors therein, as described in the patent FR 2 983 812 B1, in order to measure micro-deformations thereof and thus assess the stresses to which they are subjected, in particular during the passage of a rolling equipment. These measurements can thus be exploited in order to detect abnormal stresses linked to the passage of a defective rolling equipment, and thus detect an anomaly of the rolling equipment.

One method designed for this purpose consists of calculating the difference between the maximum value and the minimum value of a sequence of samples of a deformation signal of a sleeper during the passage of a train over this sleeper. This method, although particularly simple, only allows the most obvious anomalies to be detected.

A statistical approach can also be used to search for outlying values in the measurements. Such an approach works well in general for passenger trains, the axle load whereof is well distributed. However, this approach easily leads to errors for trains having very uneven load distributions, for example freight trains.

### DESCRIPTION OF THE INVENTION

The invention aims to provide a more robust technique for detecting an anomaly of a rolling equipment by means of a signal measuring deformation of a rail support of a railway.

The invention thus proposes a computer-implemented method for detecting an anomaly of a rolling equipment rolling on rails of a railway resting on a rail support. This method comprises a decomposition by discrete wavelet transform of a measurement signal transmitted by a strain sensor detecting the deformation of the rail support into an approximation signal and a series of detail signals. A residual signal is formed by the sum of all or part of the detail signals and the method comprises searching for outliers in the residual signal in order to detect an anomaly of the rolling equipment.

Some preferred, however non-limiting aspects of this method are as follows:

the search for outliers in the residual signal consists of searching for the points of the residual signal, the absolute value of the amplitude |rᵢ| thereof satisfies |rᵢ|>μ_{ν,R}+ασ_{ν,R}, where μ_{ν,R} is the average noise contained in the residual signal, σ_{ν,R} is the standard deviation of the noise contained in the residual signal and a is a parameter for adjusting a detection sensitivity;

it further comprises a prior step of determining a level of decomposition of the discrete wavelet transform decomposition of the measurement signal, said level of decomposition minimising a square error given by w(σ_{ν,R}−σ_{ν,S})²+(σ_{R}−σ_{ν,S})², where w is a weighting parameter, σ_{ν,R} is the standard deviation of the noise contained in the residual signal, σ_{ν,S} is the standard deviation of the noise contained in the measurement signal and σ_{R} is the standard deviation of the residual signal;

it further comprises, in the event that an anomaly of the rolling equipment is detected, classifying the anomaly detected as a first anomaly type or a second anomaly type; the anomaly detected is classified as an anomaly of the first type when it is associated with one single peak of the residual signal and is classified as an anomaly of the second type when it is associated with at least two single peaks of the residual signal of opposite signs;

the anomaly detected is classified as an anomaly of the second type when it is associated with outliers, one whereof has an amplitude that is less than a first negative threshold and another whereof has an amplitude that is greater than a second positive threshold; it further comprises a step of determining a severity of an anomaly detected; it further comprises a step of detecting peaks in the approximation signal.

### BRIEF DESCRIPTION OF THE FIGURES

Other aspects, purposes, advantages and characteristics of the invention will be better understood upon reading the following detailed description given of the non-limiting preferred embodiments of the invention, provided for illustration purposes, with reference to the accompanying figures, in which:

FIG. 1 shows one example of a measurement signal transmitted by a strain sensor detecting deformation of a rail support, this signal carrying a transient induced by an anomaly of a rolling equipment;

FIG. 2 is a close-up view of the signal in FIG. 1 focused on the transient that is characteristic of the anomaly;

FIG. 3 shows the measurement signal and the approximation signal at the top and the residual signal at the bottom, in which outliers were detected;

FIG. 4 is a close-up view of FIG. 3 focused on the transient that is characteristic of the anomaly;

FIG. 5 shows a residual signal carrying one single peak that is characteristic of an anomaly of the axle overload type;

FIG. 6 shows a residual signal carrying two single peaks of opposite signs that are characteristic of an anomaly of the wheel-flat type;

FIG. 7 shows one possible embodiment of the detection of an anomaly of the wheel-flat type;

FIG. 8 shows a measurement signal and the approximation signal thereof from which axle peaks are detected;

FIG. 9 is a flow chart of a method according to the invention.

### DETAILED DESCRIPTION OF SPECIFIC EMBODIMENTS

The invention relates to a computer-implemented method for detecting an anomaly of a rolling equipment rolling on rails of a railway resting on a rail support. The invention exploits a measurement signal transmitted by a sensor capable of measuring the deformation of a rail support of a railway. The sensor can be joined to the surface of the support or integrated into the support.

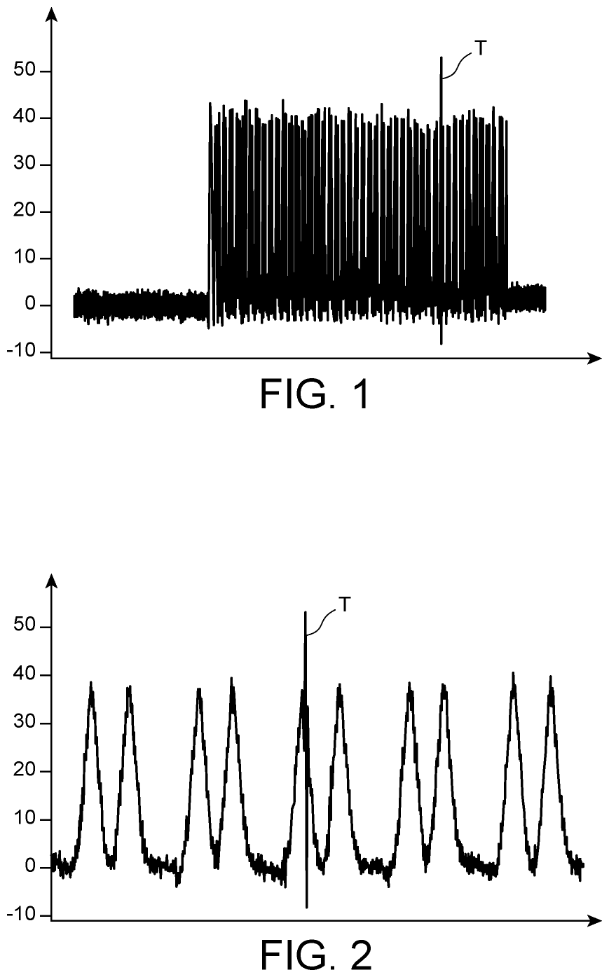

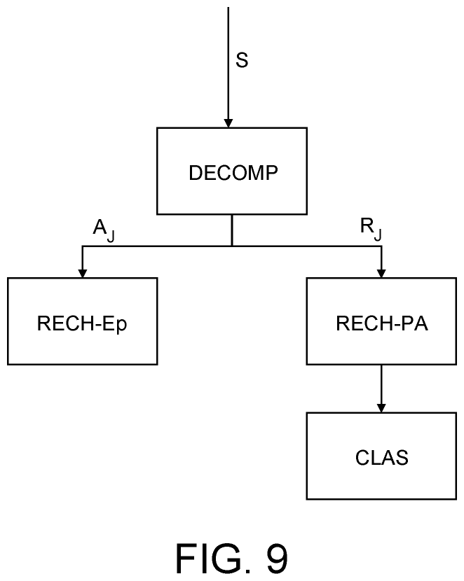

The description below considers the example of a strain sensor of the optical fibre Bragg grating type, the measurement signal whereof is, for example, sampled at 500 or 1,000 Hz. FIG. 1 shows a recording of some thirty seconds of the measurement signal transmitted by such a sensor during which a train passes over the support. This recording carries a transient T induced by an anomaly of the train. FIG. 2 is a close-up view of the signal in FIG. 1 focused on this transient T. In particular, the characteristic “M” shape of the peaks linked to the passage of the axles of the locomotives and wagons over the support equipped with the sensor can be recognised. This recording can undergo preliminary processing including drift compensation and potentially normalisation. In order to detect a transient characteristic of a rolling equipment anomaly, the method according to the invention includes, with reference to FIG. 9, a step DECOMP consisting, where appropriate after the aforementioned preliminary processing, of decomposing, by discrete wavelet transform, the measurement signal S transmitted by the strain sensor into an approximation signal A_{J} and a residual signal R_{J}. This decomposition is carried out up to a level of decomposition J according to the following conventional procedure. The measurement signal S is decomposed into an approximation signal A₁ which provides a smooth view of the original signal and into a detail signal D₁ amplifying the high-frequency components of the signal. The approximation signal A₁ is in turn decomposed into an approximation signal A₁ and into a detail signal D₂ (which thus appears as a corrective term between the two successive approximations A₁ and A₂). This procedure is repeated until the desired level of decomposition J is obtained. Ultimately, an approximation signal A_{J} and a series of detail signals D₁, D₂, . . . , D_{J} are obtained and the signal S is thus decomposed according to S=A₁+Σ_{j≤J}Dⱼ. A residual signal Rⱼ is formed with the sum of all or part of the detail signals. Thus, the residual signal can consist of the complete sum from 1 to J of the detail signals, but can also constitute a choice of specific detail signals (for example for J=3, R₃=D1+D3, D2 not included).

The decomposition of the signal S more specifically produces a set of coefficients denoted cA_{J} and cDⱼ (1≤j≤J) respectively for approximation and details. Using these coefficients, the signal S can be reconstructed at the desired level on the one hand in order to obtain the approximation A_{J} (low-frequency content) and the sum of the detail signals Σ_{i≤J}Dⱼ (high-frequency content) such that the signal S is decomposed according to S=A_{J}+Σ_{j≤J}Dⱼ, with the relation A_{J-1}=A_{J}+D_{J} between two successive approximations and

Dⱼ= [symbol] cD(j,k)ψ_{j,k}, where the variable k represents the temporal phase shift and ψ_{j,k} is the wavelet at the level j by phase-shifted k samples.

Unlike the sine and cosine functions used in the Fourier transform, the functions ψ_{j,k} are localised in time: only part of the samples is non-zero. By appropriately selecting the level of decomposition, the micro-deformation signal (i.e. the axle peaks) can be separated from the measurement noise and anomalies of the rolling equipment which are characterised by sudden transient phenomena localised in time.

The selection of the wavelet is guided by the form of the signal S to be decomposed, typically by selecting a wavelet resembling this signal. In the examples described below, the Symlet 5 wavelet is chosen.

The choice J of the level of decomposition is made so as to ensure the best possible separation compromise. In one possible embodiment, the method according to the invention comprises a prior step of determining a level of decomposition of the discrete wavelet transform decomposition of the measurement signal, said level of decomposition minimising the square error w(σ_{ν,R}−σ_{ν,S})²+(σ_{R}−σ_{ν,S})², where w is a weighting parameter, σ_{ν,R} is the standard deviation of the noise contained in the residual signal, σ_{ν,S} is the standard deviation of the noise contained in the measurement signal S and σ_{R} is the standard deviation of the residual signal.

More specifically, a good separation requires:

on the one hand, that the standard deviation of the noise contained in the residual signal σ_{ν,R} and the standard deviation of the noise in the measurement signal σ_{ν,S} are as close as possible, i.e. σ_{ν,R}≈σ_{ν,S}; and

on the other hand, that the standard deviation of the residual signal σ_{R} remains close to the standard deviation of the noise in the measurement signal σ_{ν,S}, generally slightly greater since a contribution from the axle peaks can subsist and because of the presence of an anomaly, i.e. σ_{R}≥σ_{ν,S}.

In doing so, the detail signals are guaranteed to primarily only contain the noise and the transients resulting from the presence of an anomaly.

The invention is not exclusive to this example of the chosen level of decomposition, and can be carried out according to other methods such as methods based on the energy contained in the detail signals for example.

The standard deviation of the noise contained in the measurement signal σ_{ν,S} can be easily estimated over the part of the signal recorded before the passage of the train, for example over the first n seconds in the example in FIG. 1 (where n=3 seconds for example).

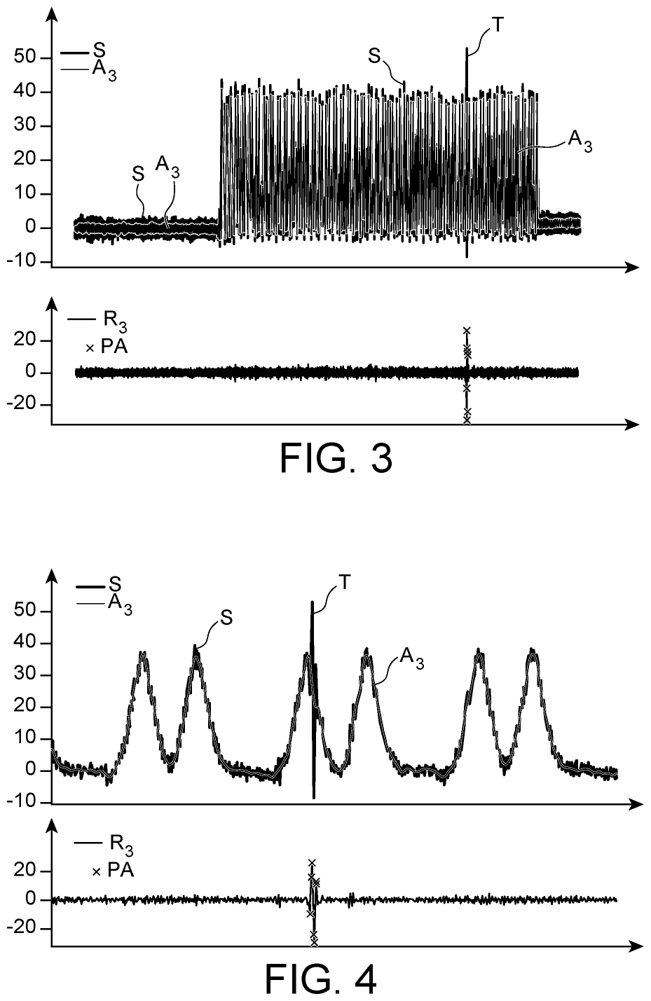

In one example embodiment exploiting the Symlet 5 wavelet, the selected level of decomposition is J=3. The top portion of FIG. 3 shows the measurement signal S and the approximation signal A₃ and the bottom portion of the same FIG. 3 shows the residual signal R₃. FIG. 4 shows a close-up view of FIG. 3 focused on the transient T that is characteristic of the anomaly. The standard deviation of the noise affecting the measurement signal σ_{ν,S} is estimated to equal 1.08592 over the first 3 seconds of the signal. The level of decomposition J=3 gives a standard deviation of the noise contained in the residual signal σ_{ν,R} equal to 1.03472 and a standard deviation of the residues σ_{R} equal to 1.20381.

In one possible embodiment, a thresholding of the coefficients of the decomposition (for example a so-called “soft coefficient thresholding”) can be implemented in order to reduce the noise level in the reconstruction and obtain a residual signal that ideally only contains the transients characteristic of potential anomalies.

After the decomposition DECOMP of the measurement signal into an approximation signal and a residual signal, the method according to the invention comprises a step RECH-PA of searching for outliers in the residual signal in order to detect an anomaly of the rolling equipment. These outliers PA appear in the form of full circles in FIGS. 3 and 4. They correspond to points that get out from noise. The detection of an anomaly occurs for a succession of outliers, for example in a time window following an outlier, the size whereof is variable as a function of the speed of the rolling equipment.

The search for outliers in the residual signal can in particular consist of searching for the points of the residual signal, the absolute value of the amplitude |rᵢ| thereof satisfies |rᵢ|>+μ_{ν,R}+ασ_{ν,R}, where μ_{ν,R} is the average noise contained in the residual signal during the first n seconds (i.e. before the passage of the train), σ_{ν,R} is the standard deviation of the noise contained in the residual signal and a is a parameter for adjusting a detection sensitivity. The average μ_{ν,R} is generally substantially equal to zero as a result of the shift compensation carried out during preliminary processing. For example, α=8 is chosen.

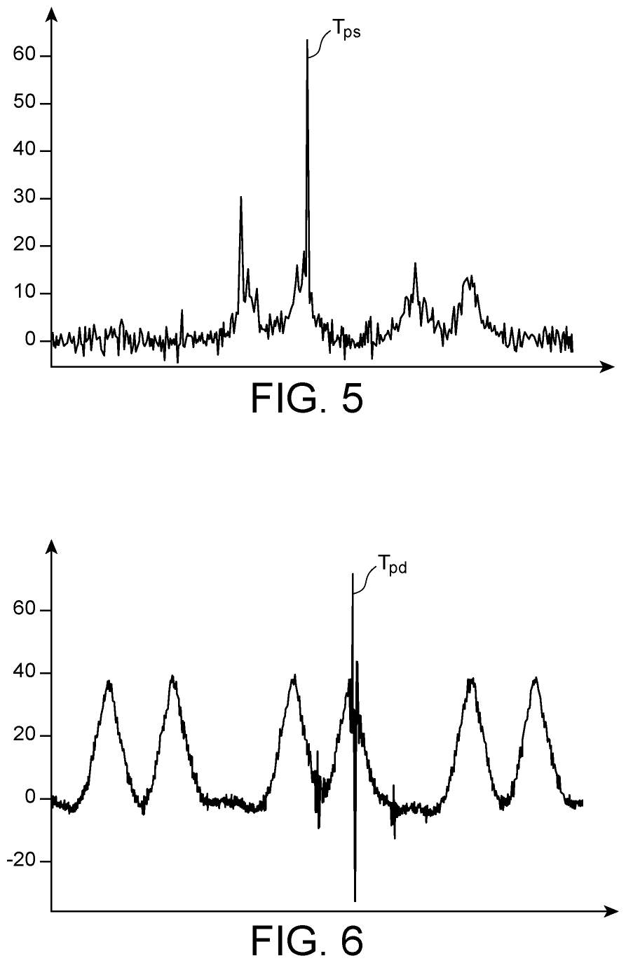

In one possible embodiment, an anomaly detected is classified CLAS, for example as a first anomaly type or as a second anomaly type, by means of an analysis of the residual signal. The first anomaly type is, for example, an axle overload which, as shown in FIG. 5, causes a transient Tps of the residual signal in the form of one single peak. The second anomaly type is, for example, a wheel-flat which, as shown in FIG. 6, causes a transient Tpd of the residual signal of the type of a sudden alternation about the “M”-shaped axle peak curve in the form of at least two single peaks of opposite signs. Thus, the anomaly detected can be classified as an anomaly of the first type when it is associated with one single peak of the residual signal and can be classified as an anomaly of the second type when it is associated with at least two single peaks of opposite signs.

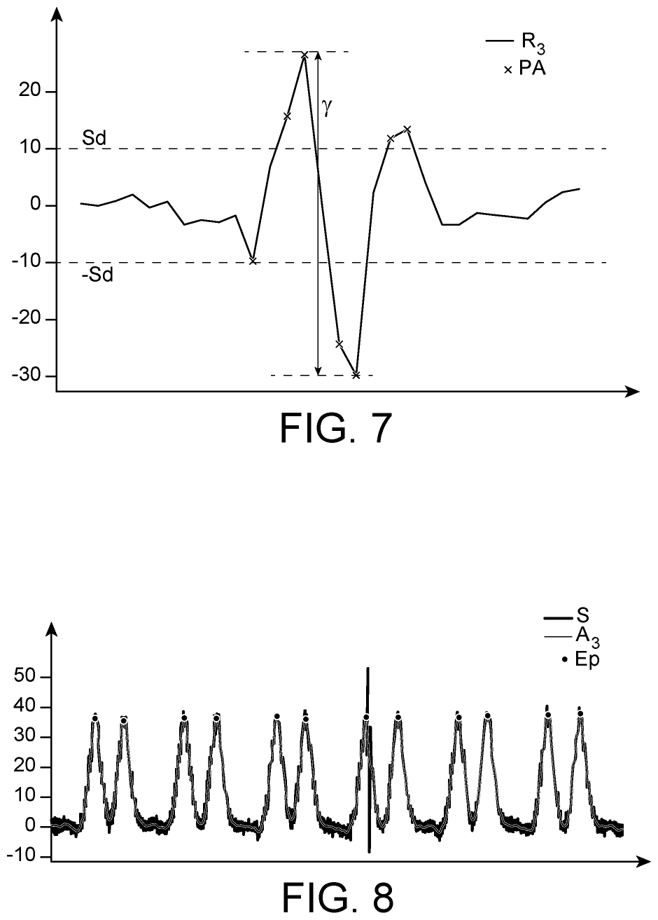

The analysis of the residual signal used to carry out this classification can exploit the outliers previously detected in order to differentiate between the different types of anomaly. For example, the anomaly detected is classified as an anomaly of the second type when it is associated with outliers, one whereof has an amplitude that is less than a first negative threshold and another whereof has an amplitude that is greater than a second positive threshold. As shown in FIG. 7, symmetric thresholds s_{d} and −s_{d} can be selected. The anomaly is thus classified as characteristic of a wheel-flat if the minimum of the outliers of the anomaly is less than −s_{d} and if the maximum of the outliers of the anomaly is greater than sd. Conversely, the anomaly is classified as being characteristic of an axle overload.

The method can further comprise a dating of an anomaly detected, for example as a function of the time of the maximum, in absolute value form, of the outliers of the anomaly, as a function of the time of the median, in absolute value form, of the outliers of the anomaly, or even as a function of the time of the first outlier of the anomaly.

The method can further comprise the determination of a severity of an anomaly detected. For example, for an anomaly of the axle overload type, this severity can correspond to the maximum of the outliers of the anomaly. For an anomaly of the wheel-flat type, this severity can, for example, correspond to the largest deviation in amplitude y (see FIG. 7) between outliers of the anomaly.

It should be noted that by having an annotated database of cases of anomalies, a supervised classification algorithm can be trained and used to effectively recognise different types of anomalies.

The detection of the transit of the axles on the support and the strain sensor thereof is generally based on peak detection algorithms which search for fast variations in the deformation measurement signal S. The adjustment parameters can be chosen so as to make these algorithms less sensitive to noise, for example by setting a minimum distance between two axle peaks or by setting a minimum variation in deformation. However, this detection is not robust against anomalies contained in the signal since these are transient phenomena that also have fast variation.

Within the scope of the invention, the reconstruction of the approximation signal A_{J} provides a signal from which measurement noise and the anomalies detected have been removed, on which the detection of axle peaks can be carried out. Thus, in one possible embodiment of the invention, the method further comprises a step RECH-Ep of detecting peaks in the approximation signal. In this respect, FIG. 8 shows the result of the detection of axle peaks EP in the area of the anomaly used in the preceding example. This robust detection of the axle peaks in particular allows for automatic recognition of the rolling equipment. More specifically, the locomotives and wagons have known and documented features, in particular the car length and location of the trucks which allow the inter-axle distances to be calculated. If two strain sensors are used, separated by a known distance, the speed of the train can be easily determined by the time difference between the deformation measurements. Exploiting the approximation signal with a low noise or anomaly level prevents distortion in the assessment of the inter-axle distances and deteriorating the automatic recognition of the rolling equipment.

The invention is not limited to the method described hereinabove, but also extends to a data processing system configured to implement same, as well as to a computer program product comprising instructions which, when the program is executed by a computer, result in the former implementing this method.

1. A computer-implemented method for detecting an anomaly of a rolling equipment rolling on railway rails resting on a rail support, comprising the steps of:
applying a wavelet transform to a measurement signal transmitted by a strain sensor detecting a deformation of the rail support thereby decomposing said measurement signal into an approximation signal and a series of detail signals,
summing all or part of the detail signals to form a residual signal;
searching for outliers in the residual signal in order to detect an anomaly of the rolling equipment.

2. The computer-implemented method according to claim 1, wherein searching for outliers in the residual signal consists of searching for points of the residual signal which have an absolute value of the amplitude |rᵢ| satisfying |rᵢ|>μ_{ν,R}+ασ_{ν,R}, where μ_{ν,R} is the average noise contained in the residual signal, σ_{ν,R} is the standard deviation of the noise contained in the residual signal and α is a parameter for adjusting a detection sensitivity.

3. The computer-implemented method according to claim 1, further comprising a prior step of determining a level of decomposition of the wavelet transform, said level of decomposition minimising a square error given by w(σ_{ν,R}−σ_{ν,S})²+(σ_{R}−σ_{ν,S})², where w is a weighting parameter, σ_{ν,R} is the standard deviation of the noise contained in the residual signal, σ_{ν,S} is the standard deviation of the noise contained in the measurement signal and σ_{R} is the standard deviation of the residual signal.

4. The computer-implemented method according to claim 1, further comprising in the event that an anomaly of the rolling equipment is detected, classifying the detected anomaly as an anomaly of a first type or of a second type.

5. The computer-implemented method according to claim 4, wherein the detected anomaly is classified as an anomaly of the first type when it is associated with one single peak of the residual signal and is classified as an anomaly of the second type when it is associated with at least two single peaks of the residual signal of opposite signs.

6. The computer-implemented method according to claim 5, wherein the detected anomaly is classified as an anomaly of the second type when it is associated with outliers, one whereof has an amplitude that is less than a first negative threshold and another whereof has an amplitude that is greater than a second positive threshold.

7. The computer-implemented method according to claim 1, further comprising a step of determining a severity of a detected anomaly.

8. The computer-implemented method according to claim 1, further comprising a step of detecting peaks in the approximation signal.

9. A data processing system configured to implement the method according to claim 1.

10. A computer program product comprising instructions which, when the program is executed by a computer, cause same to implement the method according to claim 1.
